(19) United States
(12) Patent Application Publication
(10) Pub. No.: US 2011/0147620 A1
(43) Pub. Date: Jun. 23, 2011

(54) LASER PATTERNING USING A STRUCTURED OPTICAL ELEMENT AND FOCUSED BEAM

(75) Inventors: Alan Y. ARAI, Fremont, CA (US); Fumiyo YOSHINO, Hillsboro, OR (US)

(73) Assignee: IMRA AMERICA, INC., Ann Arbor, MI (US)

(21) Appl. No.: 12/970,187

(22) Filed: Dec. 16, 2010

Related U.S. Application Data
(60) Provisional application No. 61/289,724, filed on Dec. 23, 2009.

(51) Int. Cl. B23K 26/073; B23K 26/08

(52) U.S. Cl. 250/492.1

(57) ABSTRACT

Various embodiments provide for laser patterning using a structured optical element and a focused beam. In some embodiments a structured optical element may be integrally formed on a single substrate. In some embodiments, multiple optical components may be combined in an optical path to provide a desired pattern. In at least one embodiment, a projection mask is utilized to control exposure of an object to a laser output, in combination with the controlled motion of the projection mask, the controlled motion of the object and the controlled motion of the laser beam. In some embodiments, a projection mask is utilized to control exposure of an object, and the projection mask may absorb, scatter, reflect, or attenuate a laser output. In some embodiments, the projection mask may include optical elements that vary the optical power and polarization of the transmitted laser beam over regions of the projection mask. In various embodiments, the laser system may modify material of the object. In various embodiments, the laser system may be used to probe a physical property of an object.

### FIELD OF THE INVENTION

The present invention relates to laser-based systems used for modifying or exposing material of an object, for example a workpiece.

### BACKGROUND

High laser processing speeds have been obtained with high-speed positioning systems, such as galvanometric scanning systems. For example, beam scanning speeds up to several meters/s are obtainable. However, with some lasers it is difficult, and sometimes impossible, to quickly control the laser, for example with on and off modulation. Thus, the smallest feature that can be machined, modified or exposed is relatively large:

Feature size=Translation speed×2×(Switching time interval)

where it is assumed that the on-off switching times are equal. Also, if scanning is done in multiple directions (e.g.: bi-directional), then the scan lines will be staggered (not aligned) as a result of the actuation time of the on/off control mechanism. For example, if the on/off actuation time is 1 millisecond and the translation speed is 1 m/s, the beginnings and ends of the scanned line segments will be staggered by 2 mm, again assuming the on actuation time is identical to the off actuation time.

### SUMMARY

In at least one embodiment, a structured optical element disposed between a laser source and an object controllably irradiates selected portions of the object. At least a portion of the structured optical element is configured to form a pattern of irradiation on or within the object.

The structured optical element may be representative of a non-uniform pattern of irradiation.

In some embodiments, the structured optical element may include a projection mask utilized to control exposure of an object, and the projection mask may absorb, scatter, reflect, or attenuate a laser output.

In various embodiments, the laser system may modify material of the object.

In various embodiments, the laser system may be used to probe a physical property of an object.

### BRIEF DESCRIPTION OF THE DRAWINGS

FIG. 1 schematically illustrates a diagram of a laser material system corresponding to an embodiment.

FIG. 2 illustrates an example of a laser system having galvanometer mirror scanner system.

FIG. 3 is a microscope image illustrating a raster-scanned line pattern written in polycarbonate using a galvanometer mirror system. A rectangular piece of silicon was used to form a projection mask for controlling exposure of the polycarbonate sample to the scanning laser beam.

FIG. 4 schematically illustrates the projection mask and pattern position for FIG. 3 in polycarbonate.

FIGS. 5-9 schematically illustrate examples of patterns which may be utilized in various embodiments: a display dial, the number ‘100’ made of curved lines, a circle filled with off-center raster-scanned curves, a multiphoton microscope raster-scanning pattern, and a multiphoton microscope raster-scan pattern with projection mask.

### DETAILED DESCRIPTION

Various embodiments provide laser-written patterns at high translation speeds. In at least one embodiment a structured optical element, for example a projection mask of the desired pattern, is made. The structured optical element blocks, scatters or significantly attenuates the laser light in the regions where no laser machining, modification or exposure on the target is desired, while transmitting the laser light in regions where laser machining, modification or exposure on the target is desired. A structured optical element may be configured to transmit, reflect, refract, diffract, or otherwise modify a beam to form a desired pattern of irradiation on or within at least a portion of an object. The structured optical element may be held stationary, or dynamically positioned under computer control. In various embodiments, a pattern of irradiation may vary within an illumination field on or within the object, and may comprise periodic, non-periodic, and/or other pre-determined spatial and/or spatio-temporal patterns.

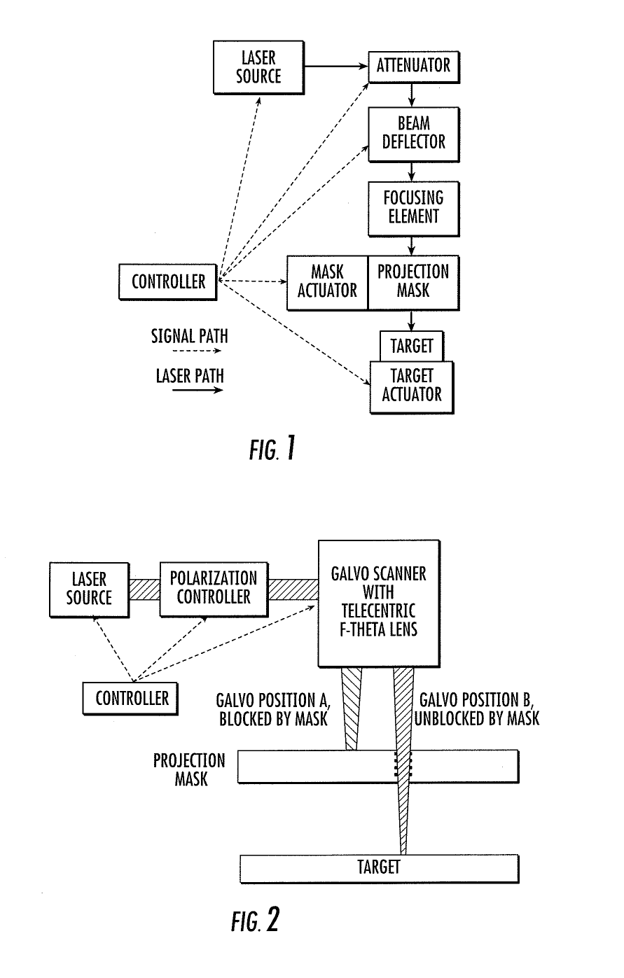

FIG. 1 schematically illustrates a diagram of a laser material system corresponding to an embodiment. In this example, a structured optical element is illustrated as a projection mask, and configured for optical transmission. The mask may be integrally formed on a single substrate. In some embodiments of a laser-based system, a structured optical element of the system may also be configured with multiple optical components combined in an optical path to provide the desired pattern of irradiation. The laser beam is emitted from the Laser Source. The laser beam optical power from the Laser Source may be reduced to a desired level using the Attenuator. In some embodiments, the laser beam polarization is also controlled. The laser beam focus is translated by the Beam Deflector. In this example the moving laser beam is focused by a Focusing Element and either blocked by the Projection Mask to avoid impinging the Target, or transmitted by the Projection Mask so as to interact with the Target and form the desired feature, modification or exposure pattern. The pattern generated on the Target may be defined by the pattern on the Projection Mask, the motion of the Projection Mask by the Mask Actuator and the motion of the Target by the Target Actuator. In this example, the Controller controls the output from the Laser Source, the power output from the Attenuator, the direction of the laser beam by the motion of the Beam Deflector, the motion of the Projection Mask by the Mask Actuator and the motion of the Target by the Target Actuator.

The laser power, controlled by the Attenuator, can be varied to change the size, depth and type of modification created by the laser in or on the Target.

The axial position (along the path of the laser beam) of the Target relative to the Focusing Element is determined such that the fluence of the focused laser beam at the Target is sufficient to produce the desired ablation or material modification after passing through the Projection Mask.

The axial position of the Projection Mask relative to the Focusing Element is set to avoid ablation or material modification of the transmissive portion of the Projection Mask by the laser beam.

In conventional mask exposure used in lithographic processes the laser beam size is much larger than the features in the mask. The laser beam often covers the entire mask area or a large portion of it. Neither high-speed translation nor fast control of the laser exposure is used. By way of example, and in contradistinction to the conventional approach, various embodiments provide for fast scan operation and do not require fast modulation to control laser outputs.

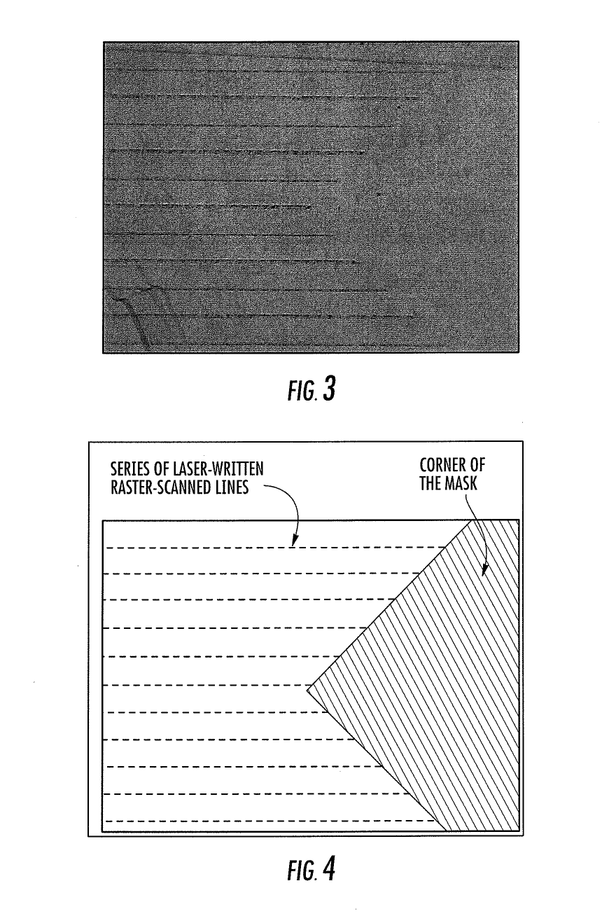

FIG. 2 shows a schematic illustration corresponding to an embodiment with the laser beam steered by a galvanometer mirror scanner and focused using a telecentric F-theta lens. At Galvo Position A, the focused beam is blocked by the projection mask and does not hit the target. At Galvo Position B, the focused beam passes through the projection mask and hits the target to create the desired material ablation or material modification.

Commercial software, such as “Image to G-Code” (http://www.imagetogcode.com/), is available that automatically writes the control code for the translation actuator to produce a desired raster-scanned image using straight lines. With current versions of this tool, it is not possible to make an image filled with non-straight lines. However, the projection mask exposure method makes it possible to machine patterns composed of non-straight, raster-scanned lines.

In at least one embodiment, a focusing optic includes a non-telecentric F-theta lens. The Projection Mask may be designed to compensate for scaling and distortion of the projection mask image on the Target when the laser beam is deflected from the center position.

In various embodiments, diffraction, scattering and reflection of the laser beam from the Projection Mask are used to create the desired pattern on the Target. Additional optical transformations can also be integrated into a structured optical element to reduce the optical power or change the polarization of the laser beam as it passes through the element. In some embodiments, incorporating these processes in the mask rather than elsewhere in the beam path has an advantage that the process can be specifically defined over a particular region of the Target and does not need to be controlled by precise timing in the control software of the actuators. These laser-exposed areas can also be defined over very small regions that would be difficult to achieve with conventional methods due to limited response times of the mechanical actuators that would be used to rotate a waveplate or attenuating filter.

The optical power can be reduced in order to change the type of material modification produced in the Target over a defined region by using optical attenuation within the Projection Mask. This material modification can, for example, range from ablation to cracking to melting and optical index change, based on both the optical attenuation in the Projection Mask and the exposure time at a particular location on the object. The location may be determined by the beam deflector, the Mask Actuator motion and the Target Actuator motion. It is known to those skilled in the art that the laser polarization affects the characteristics of the material modification.

A structured optical element may be fabricated in many different ways. As discussed above, a mask may be formed integrally on a single substrate. Alternatively, a composite of multiple materials may be utilized, which may provide for adjustment of laser processing conditions for different areas of a target. A structured optical element may be fabricated using any suitable exposure method, including lithography, thin film deposition, pulsed laser deposition and/or related deposition techniques.

By way of example, the inventors used a structured optical element to fabricate samples. Surface texturing of a polished stainless steel plate was implemented using ultrashort laser pulses and X,Y,Z positioning equipment. Regions representative of the desired pattern were not textured, by blocking the ultrashort laser pulses with optically opaque regions of a structured optical element, thereby providing for strong reflectance. Regions that were surface textured by the ultrashort laser pulses that passed through optically transparent regions of the structured optical element did not provide strong reflectance from the target, thus producing a high-contrast pattern. Additional examples of structured optical elements and exemplary applications are discussed below.

### EXAMPLE 1

By way of example, FIG. 3 is a microscope image illustrating a raster-scanned line pattern written in a polycarbonate. The pattern was written into the polycarbonate sample using a galvanometer mirror system in an arrangement similar to that of FIG. 1. A rectangular piece of silicon was used to form a projection mask for controlling exposure of the polycarbonate sample to the scanning laser beam.

A small, rectangular piece of optically opaque silicon was used as a Projection Mask. A galvanometer mirror scanner with a 100-mm focal length telecentric F-theta lens was used to focus the laser light. FIG. 3 shows an optical microscope image of sub-surface lines in polycarbonate near a corner of the rectangular Projection Mask with the laser operating at a 100 kHz repetition rate, 1045 nm wavelength, 500 fs pulse duration). The translation speed was 550 mm/s.

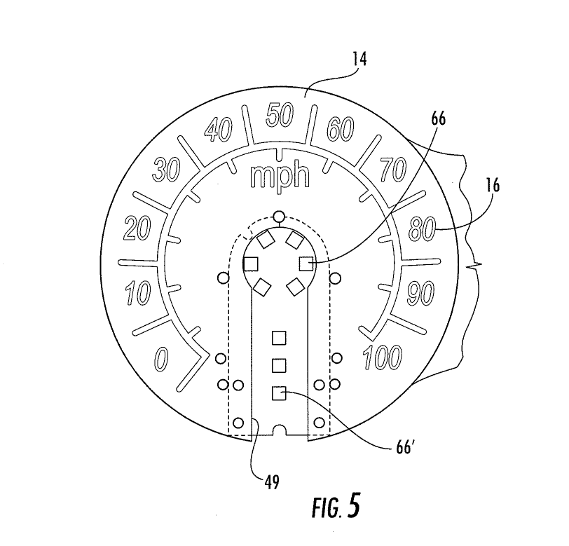

FIG. 4 schematically illustrates the projection mask and pattern position for FIG. 3 in polycarbonate, and shows the position of the Projection Mask and the laser-written raster-scanned lines. A sharply defined corner with no apparent degradation in sharpness is shown. The spacing between the lines is 150 μm. In order to produce a similarly straight edge using a shutter mechanism with the same translation speed, the shutter response time would need to be on the order of a microsecond. Such a speed is too fast for an electro-mechanical shutter. For example, the LS6 electro-mechanical shutter from Uniblitz (www.uniblitz.com), with a 6 mm optical aperture is specified with a 700 μs time to open and modulation to 400 Hz. Various electro-optic and acousto-optic modulators may provide microsecond switching timing, but are relatively expensive, require precise alignment and drive electronics, absorb some optical energy reducing the available laser power, and need precise control software to synchronize the on/off control with the beam and/or target motion. For applications where greater on/off control flexibility is necessary, optical modulators may be an alternative. For simpler patterns that do not need to be changed, the projection mask method provides the desired functionality at a lower cost.

### EXAMPLE 2

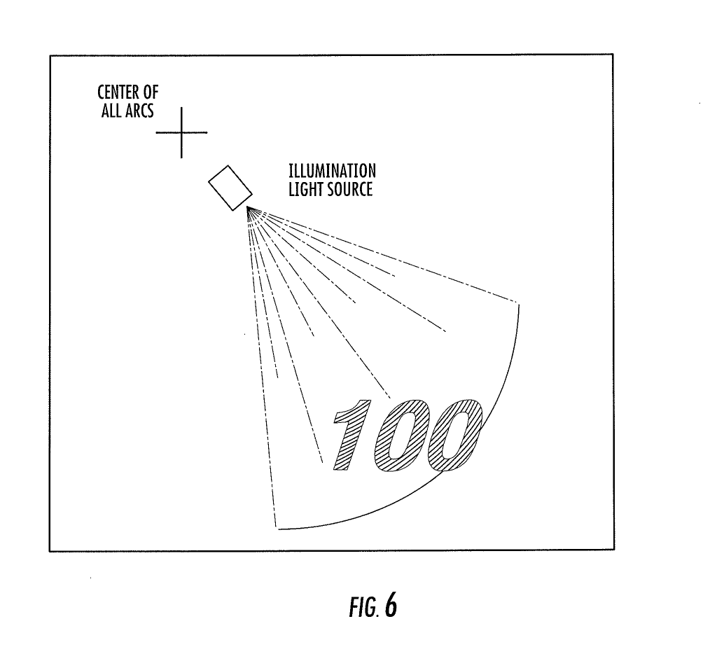

A display dial may be machined into the surface of a clear plastic using a mechanical machining process, for example as disclosed in U.S. Pat. No. 7,357,095, the contents of which are hereby incorporated by reference in their entirety. As illustrated in FIG. 5 of the present application (taken from FIG. 5 of '095) the dial is illuminated at the inner edge of the dial using a series of light sources, for example LEDs 66.

Rather than mechanically machining the dial into the surface of the plastic, laser writing of the pattern may be carried out. In at least one embodiment, a pattern is written on the surface and/or below the surface of the plastic using an ultrashort pulse laser. The laser-written pattern may be uniformly visible when the illumination source is approximately perpendicular to the direction of the raster-scanned lines used to make the pattern. When the illumination sources are near the center of an approximately circularly arranged pattern, the raster-scanned lines used to produce the pattern are arcs rather than straight lines. One method of producing curved raster-scanned lines at high speeds is using a commercially available galvanometric actuated mirror scanning system. FIG. 6 schematically illustrates the number “100” (similar to the number in the display dial), made up of curved, raster-scanned lines with a common center.

In another embodiment, the circularly arranged pattern may be divided into multiple wedge sections where each wedge is illuminated primarily by one light source. One wedge for each of the six light sources 66 shown in FIG. 5, where a wedge is roughly defined as having its vertex at the center of the circular pattern and having straight line borders radiating outwards to the outer circular border. The pattern in each wedge is then made up of straight raster-scanned lines, where the raster-scanned lines are approximately perpendicular to the beam from the light source centered in the particular wedge. The pattern in each wedge is defined by a structured optical element having a series of straight lines (not shown). This allows for fast scanning speed to be used to produce patterns within the wedge region with well-defined boundaries. The structured optical element also prevents laser modification of regions outside the targeted wedge so that only one wedge region at a time is processed.

### EXAMPLE 3

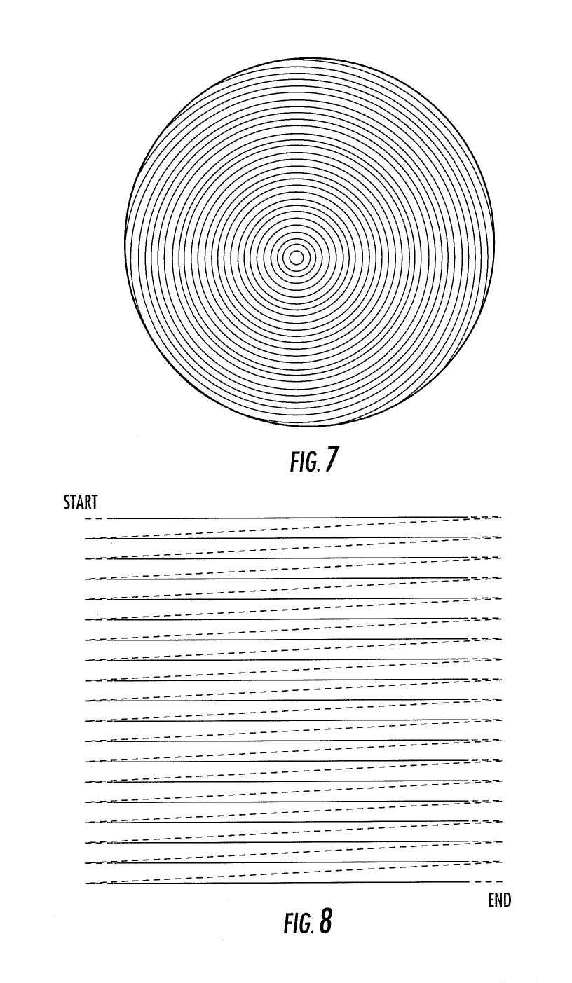

As another example, a circle may be filled with concentric rings where the center of the rings filling the circle is not at the center of the circle (FIG. 7). This gives the circle a different visual effect, more of a 3-dimensional appearance. While programming the actuation system to define the specific endpoints of the arcs is possible, a simpler solution is to use a structured optical element with the desired shape, a circle in this example. The laser beam can then be rapidly translated in the desired circular pattern using, for example a set of scanning galvanometric mirrors, to produce the desired pattern within the area defined by the structured optical element, without the need for rapidly controlling the laser on and off states or electromechanical shutter commands. Other irregular shapes and patterns are also possible and programming the paths of the raster-scanned lines becomes more complicated. More examples of complicated raster-scanned line patterns with other shapes can be made.

### EXAMPLE 4

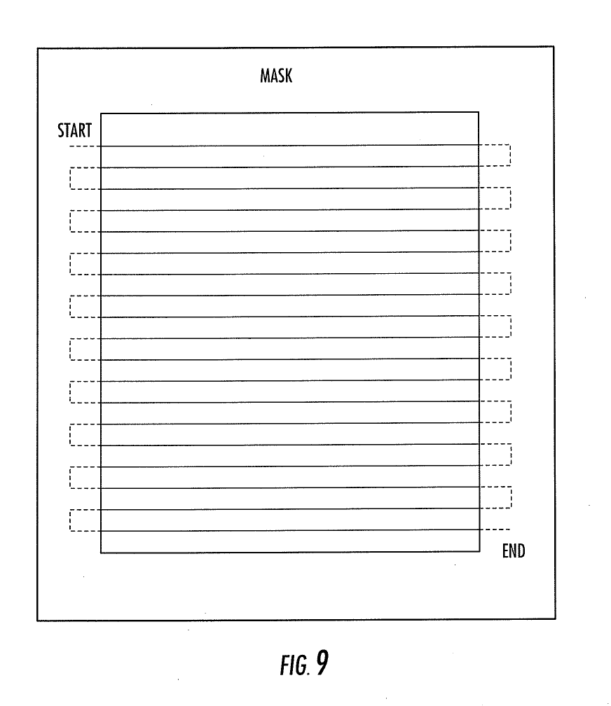

In multiphoton microscopes (MPMs), a raster-scanning pattern is used to cover the desired field of view to be imaged. At the beginning and end of each raster-scanned line, the target can be over-exposed by the illuminating laser light during the acceleration and deceleration phase of the laser beam travel as it reverses direction. FIG. 8 schematically illustrates an example of a raster-scan pattern. The laser light is off for the dashed lines and on for the solid lines.

Acousto-Optic Modulators (AOMs) are often used to quickly turn off/on laser exposure, but are known to be problematic for MPM because heating and birefringent effects can lead to beam instability. Dispersion as the beam passes through the AOM can also lead to a significantly broadened and distorted pulse. For example, see “Handbook of biological confocal microscopy”, 3^{rd} edition, p. 903. A structured optical element may be utilized to provide stable operation, and may be particularly beneficial for MPM. The structured optical element can be designed to transmit the laser light over the region to be analyzed (may be rectangular circular or any other shape) and to prevent the laser light from impinging on the sample during scan direction reversal when the beam is decelerating and accelerating, which can over-expose the sample to the laser light. Using the structured optical element, a fast and expensive AOM or other switching device with their precise control synchronization electronics is not needed.

In some implementations, an AOM may be utilized in a system having a structured optical element. Variations in the AOM thermal loading may thereby be reduced by selecting a larger AOM aperture. The larger AOM aperture allows the use of a larger laser beam, which reduces the thermal loading but also limits the AOM speed. With the lower AOM speed, a structured optical element that more precisely defines the pattern shape reduces the high speed requirement of the AOM.

### EXAMPLE 5

For thin film machining, where the thin film thickness can range between less than 100 nm up to several microns, a constant overlap of pulses is maintained throughout the process in order to produce consistent results. With a laser with a pulse repetition rate from 50 kHz to 5 MHz, a high translation speed is used for spot overlap of 20-30%. For example, with a 100 kHz repetition rate and a 20% overlap of a 25 micron diameter spot, the beam is moving at 2 m/s relative to the sample. At these speeds, making a sharp turn while maintaining constant overlap is difficult if one is limited to control of the laser, beam deflector or object translation. Precise synchronization and compensation for actuation and signal transmission delays can limit achievable performance. Using a structured optical element can simplify the procedure to make this type of feature.

In various embodiments, a structured optical element can be designed to expose the desired region to the raster-scanning laser light, but block the laser light at the ends of each exposed line segment. The configuration will eliminate a need for the high-speed modulator and prevent over-exposure of the target during acceleration and deceleration. Scanning in both directions is then possible, reducing the time to cover the desired field of view. With this arrangement maintaining proper alignment of the ends of the line segments can be performed without more complicated system control coding to account for actuation delay times. FIG. 9 schematically illustrates a raster-scan pattern where the thin, dashed lines are the part of the raster-scan that are blocked by a projection mask (defined by the thick, solid lines) and the thin, solid lines are the part of the raster-scan that are transmitted by the projection mask.

Many Implementations are Possible, for Example:

A beam positioner may include any suitable electro-mechanical scanner, diffractive scanner and/or electro-optic deflector. In some embodiments, one or more of a linear galvanometer mirror, resonant scanner, vibration scanner, acousto-optic deflector, rotating prism, polygon, and/or other beam mover may be utilized. A high-speed electro-optic or acousto-optic deflector/modulator may be utilized in some embodiments. In some embodiments a piezo-electric positioning mechanism may be used.

An actuator coupled to the structured optical element may include an X, Y, Z and/or rotational stage. A piezo-electric positioner may be utilized in some implementations.

An actuator coupled to the target may include an X, Y, Z and/or rotational stage. A piezo-electric positioner may be utilized in some implementations.

In at least one embodiment, an optical system may include beam delivery/focusing elements. The optical system may include any suitable combination of reflective, refractive, and/or diffractive optics. In some embodiments, a dynamic focus mechanism may be utilized to control focusing over a field.

A structured optical element disposed between the laser source and object may be formed of metal, dielectric, polymer and/or semiconductor material. The structured optical element may be formed so as to provide for positioning at or near focused or defocused position within a beam path.

In some embodiments, a structured optical element of a laser system may include multiple optical components arranged along an optical path and controllably positioned relative to each other. In various embodiments a structured optical element may be integrated on a single substrate and configured to perform various beam transformations, for example attenuation, diffraction, refraction and/or scattering of an input beam.

An optical component disposed between the beam and object may include a Spatial Light Modulator, which allows a mask pattern to be changed. The configuration can be useful for marking identification numbers which need to be changed for each marking.

An electro-mechanical shutter may be utilized in some embodiments where portions of the targeted pattern utilize slow translation speeds or where precise processing conditions are not required.

Material modification and interaction techniques may include probing, surface treatment, soldering, welding, cutting, drilling, marking, trimming, macro/micro/nano structure forming, macro/micro/nano structure modification, doping, link making, refractive index modification, multiphoton microscopy, repair, creation of compounds and/or micro fabrication.

A laser source may be operated quasi-CW or pulsed, and may include q-switched, mode-locked and/or gain-switched configurations. In some embodiments, fiber lasers and/or amplifiers may be utilized. Laser pulse widths may be in a range from about 100 fs to about 500 ns. Pulse energies may be in the range from about 1 nJ up to about 1 mJ. Spot sizes at or within the object may be in the range from about a few microns to about 250 microns. For pulsed operation repetition rates may be in the range from about 100 Hz up to about 100 GHz, depending on the type of laser utilized.

In various embodiments, multiple laser sources and/or beams may be utilized, for example with a large structured optical element, and may provide for parallel processing. The laser outputs may have different energies, peak powers, wavelengths, polarizations and/or pulse widths. Scan speed may be in an effective range from about 500 Hz to about 50 KHz.

Laser pulses in the fs, ps, and/or ns regime may be utilized for processing applications. With fs pulse lasers complete blocking the light with a portion of the structured optical element may not be necessary. With fs pulses a material modification threshold is often well determined, and the structured optical element need only modify the beam so that the focused fluence is below a processing threshold. Attenuation and/or defocusing may be sufficient. In some embodiments, when longer pulses are utilized, attenuation by several orders of magnitude and/or blocking of the pulses may be preferred.

Thus, the inventors have described the invention in several embodiments. At least one embodiment includes a laser-based system for delivery of laser energy to at least a portion of an object. The system includes: a laser source providing an input beam and a beam positioner receiving the input beam and generating a moving laser beam. A structured optical element is disposed between the laser source and the object, and configured to receive the moving beam and to controllably irradiate selected portions of the object. A portion of the structured optical element is configured to form a pattern of irradiation on or within the object, and a portion of the structured optical element is configured to substantially prevent laser energy from impinging on the object, and to avoid overexposure of the target during acceleration and/or deceleration of the beam relative to the target. The system also includes a controller coupled to at least the beam positioner.

In some embodiments, a laser system is configured to modify material of the object.

In some embodiments, a beam positioner is configured to control at least one of a position and speed of a moving laser beam focus so as to modify material of an object with one or more of ablation, melting, cracking, oxidation and an optical index change.

In some embodiments, a focusing element is disposed between a beam positioner and the structured optical element.

In some embodiments, the structured optical element includes one or more of light blocking, light transmitting, light attenuation and polarization control elements corresponding with pre-determined regions of the object, and wherein the light blocking, light transmitting, light attenuation, and polarization effects occur only within the pre-determined regions of the object.

In some embodiments, a laser system is configured to probe an object and measure one or more of a physical, electrical, optical and chemical property of the object.

Some embodiments include a modulator to control an output of the laser source.

At least one embodiment includes: a laser-based method of operating the laser-based system to modify or probe an object.

At least one embodiment includes: a product having a spatial pattern formed on or within a portion of the product. The spatial pattern may be formed using the above method.

At least one embodiment includes a laser-based system for delivery of laser energy to at least a portion of an object. The system includes: a laser source providing an input beam and a beam positioner receiving the input beam and generating a moving laser beam. A structured optical element is disposed between the laser source and the object, and configured to receive the moving beam and to controllably irradiate selected portions of the object. A portion of the structured optical element is configured to form a pattern of irradiation on or within the object, and a portion of the structured optical element is configured to substantially prevent laser energy from impinging on the object and to avoid overexposure of the target during acceleration and/or deceleration of the beam relative to the target. A focusing optic is disposed in an optical path between the beam positioner and the projection mask to provide a focused output beam from the laser source. A first actuator is included for positioning the structured optical element, and a second actuator for positioning the object. A controller, is coupled to one or more of the beam positioner, the second actuator, the first actuator and the laser source, to generate a pre-determined pattern of laser exposure on the object by the focused output beam from the laser source, wherein the pattern on the object is defined by the displacement of the beam positioner, the motion of the object, the motion of the structured optical element and a pattern on or within the structured optical element.

In some embodiments, the system includes an optical system disposed between the source and an object, the optical system having one or more optical components in a common optical path with the source and the structured optical element.

In some embodiments, one or more optical components may include one or more of a mirror, an optical attenuating filter, a spatial light modulator and a waveplate.

In some embodiments, the laser based system includes an optical system disposed between the source and the object, the optical system having one or more optical components in a common optical path with the source and the structured optical element.

In some embodiments, one or more optical components include one or more of a mirror, an optical attenuating filter, a spatial light modulator and a waveplate

In some embodiments, a beam positioner includes one or more of an electro-mechanical scanner, diffractive scanner, piezo-electric positioner and electro-optic deflector.

In some embodiments, a beam positioner includes one or more of an electro-mechanical scanner, diffractive scanner, piezo-electric positioner and electro-optic deflector.

In some embodiments, a structured optical element is integrally formed on a single substrate.

In some embodiments, the structured optical element includes multiple optical components configured to controllably irradiate the selected portions of the object.

In some embodiments, a structured optical element includes multiple optical components configured to controllably irradiate selected portions of the object.

At least one embodiment includes: a laser-based system for delivery of laser energy to at least a portion of an object. The system includes: a laser source providing an input beam, and a beam positioner receiving the input beam and generating a moving laser beam. A projection mask is disposed between the laser source and the object. The projection mask is configured to receive the moving beam and to controllably irradiate selected portions of the object. A portion of the projection mask is configured to form a pattern of irradiation on or within the object, and a portion of the projection mask is configured to substantially prevent laser energy from impinging on the object and to avoid overexposure of the target during acceleration and/or deceleration of the beam relative to the target. A focusing optic is disposed in an optical path between the beam positioner and the projection mask to provide a focused output beam from the laser source. A mask actuator is included for positioning the projection mask, and an object actuator is included for positioning the object. A controller, is coupled to one or more of the beam positioner, the object actuator, the mask actuator and the laser source, to generate a pre-determined pattern of laser exposure on the object by the focused output beam from the laser source, wherein the pattern on the object is defined by the displacement of the beam positioner, the motion of the object, the motion of the projection mask and a pattern on or within the projection mask.

In some embodiments, a projection mask is integrally formed on a single substrate.

In some embodiments, a projection mask includes multiple optical components configured to controllably irradiate selected portions of the object.

In some embodiments, a portion of the projection mask is configured to form a pattern of irradiation on or within the object is configured as a refractive, reflective, or diffractive portion.

In some embodiments, a projection mask includes a spatial light modulator.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Also, the indefinite article “a” is to be understood as “at least one”, and not restricted to “one and only one”, and may include multiple features, structures, steps, processes, or characteristics unless otherwise specified.

While certain embodiments of the disclosure have been described, these embodiments have been presented by way of example only, and are not intended to limit the scope of the disclosure. No single feature or group of features is necessary for or required to be included in any particular embodiment. Reference throughout this disclosure to “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this disclosure are not necessarily all referring to the same embodiment and may refer to one or more of the same or different embodiments. Indeed, the novel methods and systems described herein may be embodied in a variety of other forms; furthermore, various omissions, additions, substitutions, equivalents, rearrangements, and changes in the form of the embodiments described herein may be made without departing from the spirit of the inventions described herein.

For purposes of summarizing aspects of the disclosure, certain objects and advantages of particular embodiments are described in this disclosure. It is to be understood that not necessarily all such objects or advantages may be achieved in accordance with any particular embodiment. Thus, for example, those skilled in the art will recognize that embodiments may be provided or carried out in a manner that achieves or optimizes one advantage or group of advantages as taught herein without necessarily achieving other objects or advantages as may be taught or suggested herein.

The above description of the embodiments has been given by way of example only. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A laser-based system for delivery of laser energy to at least a portion of an object, said system comprising:
a laser source providing an input beam;
a beam positioner receiving said input beam and generating a moving laser beam;
a structured optical element disposed between said laser source and said object, said structured optical element configured to receive said moving beam and to controllably irradiate selected portions of said object, a portion of said structured optical element being configured to form a pattern of irradiation on or within said object, and a portion of said structured optical element being configured to substantially prevent laser energy from impinging on said object and to avoid overexposure of said target during acceleration and/or deceleration of said beam relative to said target;
a controller coupled to at least said beam positioner.

2. The system of claim 1, wherein said laser system is configured to modify material of the object.

3. The system of claim 1, wherein said beam positioner is configured to control at least one of a position and speed of a moving laser beam focus so as to modify material of said object with one or more of ablation, melting, cracking, oxidation and an optical index change.

4. The system of claim 1, further comprising a focusing element disposed between said beam positioner and said structured optical element.

5. The system of claim 1, wherein said structured optical element comprises one or more of light blocking, light transmitting, light attenuation and polarization control elements corresponding with pre-determined regions of said object, and wherein said light blocking, light transmitting, light attenuation, and polarization effects occur only within said pre-determined regions of said object.

6. The system of claim 1, wherein said laser system is configured to probe said object and measure one or more of a physical, electrical, optical and chemical property of said object.

7. The system of claim 1, further comprising a modulator to control an output of said laser source.

8. A method, comprising: operating the laser based system of claim 1 to modify or probe an object.

9. A product having a spatial pattern formed on or within a portion of said product, said spatial pattern formed using the method of claim 5.

10. A laser-based system for delivery of laser energy to at least a portion of an object, said system comprising:
a laser source providing an input beam;
a beam positioner receiving said input beam and generating a moving laser beam;
a structured optical element disposed between said laser source and said object, said structured optical element configured to receive said moving beam and to controllably irradiate selected portions of said object, a portion of said structured optical element being configured to form a pattern of irradiation on or within said object, and a portion of said structured optical element being configured to substantially prevent laser energy from impinging on said object and to avoid overexposure of said target during acceleration and/or deceleration of said beam relative to said target;
a focusing optic disposed in an optical path between said beam positioner and said projection mask to provide a focused output beam from said laser source;
a first actuator for positioning said structured optical element;
a second actuator for positioning said object;
a controller, coupled to one or more of said beam positioner, said second actuator, said first actuator and said laser source, to generate a pre-determined pattern of laser exposure on said object by said focused output beam from said laser source, wherein said pattern on said object is defined by the displacement of said beam positioner, the motion of said object, the motion of said structured optical element and a pattern on or within said structured optical element.

11. The laser based system of claim 1, said system comprising an optical system disposed between said source and said object, said optical system comprising one or more optical components in a common optical path with said source and said structured optical element.

12. The laser based system of claim 11, wherein said one or more optical components comprise one or more of a mirror, an optical attenuating filter, a spatial light modulator and a waveplate.

13. The laser based system of claim 10, said system comprising an optical system disposed between said source and said object, said optical system comprising one or more optical components in a common optical path with said source and said structured optical element.

14. The laser based system of claim 13, wherein said one or more optical components comprise one or more of a mirror, an optical attenuating filter, a spatial light modulator and a waveplate

15. The laser based system of claim 1, wherein said beam positioner comprises one or more of an electro-mechanical scanner, diffractive scanner, piezo-electric positioner and electro-optic deflector.

16. The laser based system of claim 10, wherein said beam positioner comprises one or more of an electro-mechanical scanner, diffractive scanner, piezo-electric positioner and electro-optic deflector.

17. The laser based system of claim 1, wherein said structured optical element is integrally formed on a single substrate.

18. The laser based system of claim 10, wherein said structured optical element is integrally formed on a single substrate.

19. The laser based system of claim 1, wherein said structured optical element comprises multiple optical components configured to controllably irradiate said selected portions of said object.

20. The laser based system of claim 10, wherein said structured optical element comprises multiple optical components configured to controllably irradiate said selected portions of said object.

21. A laser-based system for delivery of laser energy to at least a portion of an object, said system comprising:
a laser source providing an input beam;
a beam positioner receiving said input beam and generating a moving laser beam;
a projection mask disposed between said laser source and said object, said projection mask configured to receive said moving beam and to controllably irradiate selected portions of said object, a portion of said projection mask being configured to form a pattern of irradiation on or within said object, and a portion of said projection mask being configured to substantially prevent laser energy from impinging on said object and to avoid overexposure of said target during acceleration and/or deceleration of said beam relative to said target;
a focusing optic disposed in an optical path between said beam positioner and said projection mask to provide a focused output beam from said laser source;
a mask actuator for positioning said projection mask;
an object actuator for positioning said object;
a controller, coupled to one or more of said beam positioner, said object actuator, said mask actuator and said laser source, to generate a pre-determined pattern of laser exposure on said object by said focused output beam from said laser source, wherein said pattern on said object is defined by the displacement of said beam positioner, the motion of said object, the motion of said projection mask and a pattern on or within said projection mask.

22. The laser based system of claim 21, wherein a said projection mask is integrally formed on a single substrate.

23. The laser based system of claim 21, wherein said projection mask comprises multiple optical components configured to controllably irradiate said selected portions of said object.

24. The laser based system of claim 21, wherein a portion of said projection mask is configured to form a pattern of irradiation on or within said object is configured as a refractive, reflective, or diffractive portion.

25. The laser based system of claim 21, wherein said projection mask comprises a spatial light modulator.
